(19) United States
(12) Patent Application Publication
(10) Pub. No.: US 2007/0269559 A1
(43) Pub. Date: Nov. 22, 2007

(54) EDIBLE, COLORABLE FROZEN NOVELTY, AND METHOD FOR COLORING

(75) Inventor: Frank SANTANGELO, Orange, CA (US)

Correspondence Address: BIRCH STEWART KOLASCH & BIRCH, PO BOX 747, FALLS CHURCH, VA, 22040-0747, US

(73) Assignee: COMPLETE SALES SOLUTIONS, Orange, CA (US)

(21) Appl. No.: 11/750,278

(22) Filed: May 17, 2007

Related U.S. Application Data
(60) Provisional application No. 60/747,650, filed on May 18, 2006.

(51) Int. Cl. A23G 9/00

(52) U.S. Cl. 426/101

(57) ABSTRACT

An edible frozen novelty having an ice cream or ice based product which may have an icing, glaze or other coating that can be colored with an image or that is manufactured with an edible ink outline of an image that is suitable for coloring. The frozen novelties are packaged with one or more alcohol based edible ink coloring tools. The coloring tools are used to color the novelty for the amusement of the user. The frozen novelties are either in the traditional shape of a frozen novelty or preformed in the general shape of the outline of the image borne thereon. The frozen novelties may be distributed in groups of thematically related images. Some thematic images may include animals, cars, trains, insects, holiday themes, licensed characters, etc.

### BACKGROUND OF THE INVENTION

1. Field of the Invention

The present invention generally relates to edible frozen novelties and more particularly, to an edible, frozen novelty that can be colored with an image or that is manufactured with an image thereon which can be colored and a kit containing such frozen novelties with edible ink coloring tools.

2. Discussion of the Background

It is generally known in the art of confections to provide cakes, cookies and other baked goods which bear images, such as decorated birthday cakes. Images are applied by the baker using edible coloring agents. It is also known in the art of childhood amusements to provide “coloring books” which contain black and white outline images to be colored in with crayons, colored pencils, paint or ink markers. Children are amused by the process of coloring in the images.

U.S. published application 2001/0043969 shows a cookie or other confection which has icing printed thereon including an outline for coloring an image. The cookies can be sold in a kit containing coloring tools so that the cookie can be colored by children before eating.

Heretofore, it has not been known or suggested to combine edible frozen novelties with similar edible coloring agents used for confections to provide an amusement for the children by coloring the frozen novelty.

### SUMMARY OF THE INVENTION

It is therefore an object of the invention to provide a frozen novelty with an edible ink suitable for coloring.

It is also an object of the invention to provide a childhood amusement.

It is a further object of the invention to provide a method for coloring frozen novelties.

It is a still further object of the invention to provide a frozen novelty which can be colored by the user.

It is a still further object of the invention to provide a frozen novelty with an icing, glaze or other coating that can be colored with an image or that is imprinted with an outline which can be colored.

It is still another object of the invention to provide a kit containing a frozen novelty which may be colored and a coloring tool to provide an amusement by either creating or coloring in an image.

It is still another object of the invention to provide a kit containing an edible frozen novelty and a coloring tool.

These and other objects are accomplished by providing an edible frozen novelty such as an ice cream or ice based product which may have an icing, glaze or other coating that can be colored by a customer or is imprinted with an edible ink-, outline of an image suitable for coloring. The frozen novelty is distributed with one or more alcohol based edible ink coloring tools. The frozen novelties are in the traditional shape of a frozen novelty or preformed in the general shape of the outline of the image borne thereon. The frozen novelties of the invention may be distributed in groups of thematically related images, such as animals, cars, trains, insects, holiday themes, licensed characters, etc.

Additional objects and advantages of the invention will become apparent to those skilled in the art upon reference to the detailed description taken in conjunction with the provided figures.

### BRIEF DESCRIPTION OF THE DRAWINGS

The invention may be understood by referring to the detailed description which follows, read in conjunction with the accompanying drawings in which;

FIG. 1 is a plan view of a frozen novelty according to the invention in the traditional shape of a frozen novelty;

FIG. 2 is a plan view of a frozen novelty according to the invention in the general shape of the outline of the image borne thereon;

FIG. 3 is a plan view of a kit according to the invention; and

FIG. 4 is a plan view of the packaging of the frozen novelty.

### DETAILED DESCRIPTION OF THE PREFERRED EMBODIMENTS

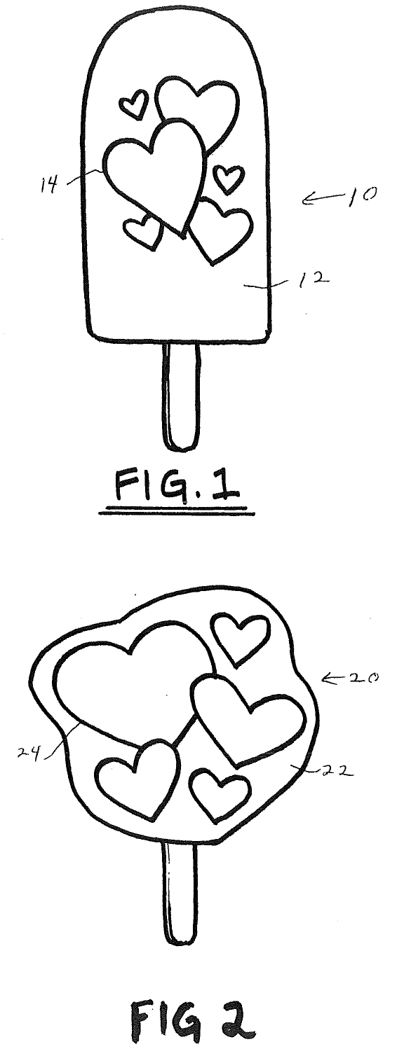

The present invention will become more fully understood from the detailed description given herein below and the accompanying drawings, which are given by way of illustration only, and thus are not limitative of the present invention, and wherein FIG. 1 shows an edible frozen novelty 10 according to the invention as including a surface 12 which is imprinted with an outline image 14. According to one embodiment, the surface 12 of the frozen novelty 10 does not contain any imprinted image, but is comprised of a coating that is capable of being colored with edible ink with any image desired by a customer/user. In another embodiment, the top surface 12 may have an icing, glaze or other coating imprinted with an edible ink outline of an image 14 suitable for coloring. The surface 14 is adapted to receive thereon edible ink of various colors to color the image.

The frozen novelty 10 is in a traditional shape as such as the shape of a traditional ice cream bar or ice pop. The coating 12 can cover the entire surface of the bar or can be used only in the area of the outline image. While the outline has been described as being drawn in ink, it would also be possible to mark the outline by use of an indentation or raised portion or in any other fashion which would still allow the novelty to be eaten and make the outline visible.

FIG. 2 shows an edible frozen novelty 20 which differs from the novelty 10 shown in FIG. 1 by having a different shape. The shape of the novelty corresponds in some fashion to the shape of the image which is provided thereon. The surface 22 corresponds to the surface 12 in FIG. 1 and includes an outline image 24, which corresponds to image 14 in FIG. 1. The surface may be made of an icing, glaze or other coating and is adapted to receive the edible ink in a similar fashion to FIG. 1.

One surface composition for coating 12 contains a mixture of sugar, partially hydrogenated palm kernel oil, reduced mineral whey powder, whole milk solids, soya lecithin, salt and artificial flavor. Another useful coating consists of sugar, cocoa butter, nonfat dry milk, milk fat, soy lecithin and vanilla. Another useful coating consists of pasteurized egg yolks and water. Still another useful coating consists of confectioners sugar and water.

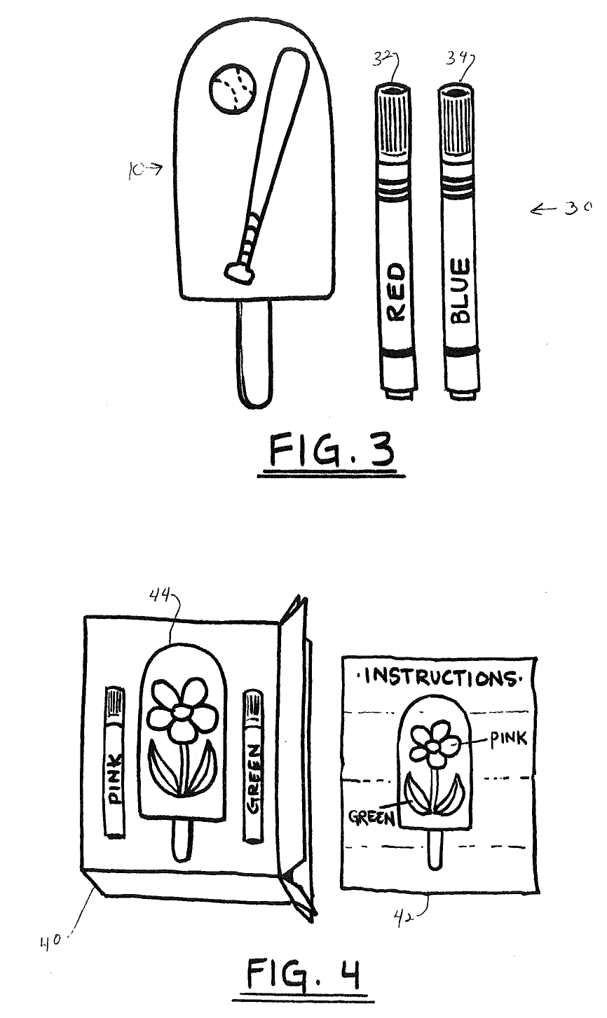

Referring now to FIG. 3, according to the invention, a kit 30 is provided containing one or more frozen novelties 10 with one or more flavored alcohol based ink tools 32, 34.

The kit may contain more the one frozen novelty and it may contain a different number of coloring tools. It is presumed that the kit would be packaged into a box or other container for marketing purposes. Although the two coloring tools shown are indicated as being the colors red and blue, any set of colors can be utilized which would correspond to the image shown. It would also be possible, if a large enough kit is provided to have a general assortment of colors, especially if more than one design is provided on the novelties.

Furthermore, while the invention has been described as utilizing outlines of images to which the colors apply, it would also be possible to provide the novelty without an image so that the child can draw his own images using an assortment of colors. It is also possible that the novelties provided could be formed without the coating of icing or glaze, if the surface of the original novelty is susceptible to coloring.

FIG. 4 shows the packaging arrangement 40 for the kit according to the present invention. The packaging includes a box 40 or similar container. A surface of the box indicates by the use of indicia 44, the particular outline image which is provided on the novelty, the shape of the novelty and the colors of the markers provided. Of course, other indicia such as the manufacturer's name, trademarks, required nutritional information and other information may also be applied as desired. The package also includes therein an instruction sheet 42 which can provide an indication of which color should be used in which parts of the outline. While not shown in FIG. 4, the kit itself including the coloring tools and novelties provided in FIG. 3 are also included in the package 40. The frozen novelty is preferably distributed in groups of thematically related images. Some thematic images contemplated by this invention include but are not limited to animals, cars, trains, insects, holiday themes, licensed characters, etc.

The presently preferred ink coloring tools contain a mixture of water, glycerine, ethyl alcohol, natural and artificial flavorings and food dyes. One composition useful for ink coloring markers consists of a mixture of water and propylene glycol, and may contain one or more of the following: US Certified Food Colors: Red 3, Red 40, Blue 1, Blue 2, Yellow 5, Yellow 6, Citric Acid, less than 0.1% of sodium benzoate and potassium sorbate (as preservatives).

A first example of an edible ink according to the invention is set forth in Table 1 below. Other types of edible inks may also be utilized as long as they are safe to be eaten and meet necessary food and drug requirements. However, the inks must be made so that they may be used when in contact with a frozen novelty.

TABLE 1

| Ingredient | Relative Amount |
|---|---|
| Water | 36.59% |
| Glycerine | 30.96% |
| Ethyl Alcohol | 28.14% |
| Coloring | 2.81% |
| Flavoring | 2.5% |

According to the invention, the coloring may include one or more of the following edible dyes: FD&C yellow #5, FD&C blue #1, FD&C red #40, and FD&C red #3. However, any type of edible coloring may be utilized as long as it is safe to eat.

Another formulation of the edible ink according to the invention is set forth in Table 2, below.

TABLE 2

| Ingredient | Quantity |
|---|---|
| Water | 27,300 grams |
| Glycerine | 23,100 grams |
| Ethyl Alcohol | 21,000 grams |
| Coloring | 1,070 grams |
| Flavoring | according to color |

According to the invention, the flavoring is preferably a natural or artificial flavoring. The edible ink is preferably dispensed from a conventional felt or other porous tip plastic marker normally covered by a cap. However, any type of dispenser may be utilized which is receptive to the edible inkl and which provides a suitable flow. A brush may also be used. The ink is fast drying when applied but slow drying within the marker. According to the invention, a marker containing ink can be left uncovered for approximately six hours without drying out.

The methods of coloring the frozen novelty may be undertaken as an individual or group activity. Thus, the coloring may be a suitable activity for a birthday party or other gathering or may be used as merely an activity by a single child. Various sizes of packages may be sold so that a larger package having, for example, a variety of designs and a larger number of coloring tools may be used for a party while a smaller package may be sold for an individual.

For making a frozen novelty with an imprinted image, one useful process consists of utilizing the above discussed coloring tools and edible inks to draw, stencil or stamp an image upon the frozen novelty, and then to lightly wash that image with water or alcohol. The wash process results in a stained image or outline that is suitable for coloring, is not subject to smearing or alteration, and does not compromise the integrity of coating.

While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope so claimed.

1. An edible frozen novelty, comprising:
a shaped frozen product; and
said product having a surface, wherein said surface comprises a coating capable of
receiving and retaining edible ink.

2. The edible frozen novelty according to claim 1, wherein said surface having an outline of an image suitable for coloring.

3. The edible frozen novelty according to claim 2, wherein the shaped frozen product is in a traditional shape of a frozen novelty.

4. The edible frozen novelty according to claim 2, wherein the shaped frozen product is in a general shape of the outline of the image.

5. The edible frozen novelty according to claim 1 or 2, wherein the surface is formed with an icing, glaze or other coating.

6. The edible frozen novelty according to claim 2, wherein the outline is formed with an edible ink which is imprinted thereon.

7. The edible frozen novelty according to claim 4, wherein the outline is formed with an edible inkl which is imprinted thereon.

8. The edible frozen novelty according to claim 1, wherein the frozen product is ice cream.

9. The edible frozen novelty according to claim 1, wherein the frozen product is an ice based product.

10. The edible frozen novelty according to claim 2, wherein the image is selected from a group consisting of animals, cars, trains, insects, holiday themes and licensed characters.

11. A kit for coloring a frozen novelty, comprising:
an edible frozen novelty having a surface capable of receiving and retaining edible ink; and
at least one coloring tool for marking edible ink in accordance with a desired outline.

12. The kit according to claim 11, wherein said surface comprises an outline of an image marked thereon for coloring with said coloring tool.

13. The kit according to claim 11 or 12 wherein the kit includes at least two coloring tools.

14. The kit according to claim 12, further comprising packaging which indicates a portion of the image which corresponds to each color.

15. The kit according to claim 11 or 12, wherein the kit includes a plurality of edible frozen novelties.

16. A method of coloring an edible frozen novelty comprising:
indicating an outline image on a surface of the edible frozen novelty; and
providing at least one coloring tool containing edible ink.

17. A method according to claim 16, wherein at least two tools are provided.

18. A method according to claim 16, further comprising marking a portion of the outline image with edible ink from the coloring tool.

19. A coloring tool, comprising:
a housing suitable to be held in a hand;
an ink reservoir contained in said housing;
an applicator contained in said housing and in communication with said ink, reservoir; and
edible ink stored in said reservoir.

20. The coloring tool according to claim 19 wherein said housing is a marker and said applicator comprises a felt tip.

21. The coloring tool according to claim 19, wherein said housing is a marker and said applicator comprises a porous tip.
